(19) United States
(12) Patent Application Publication
(10) Pub. No.: US 2008/0245016 A1
(43) Pub. Date: Oct. 9, 2008

(54) Wall cladding system with adhesive ribbons and trowel and push box for making ribbons

(75) Inventor: Peter Culyer, Barrie (CA)

Correspondence Address: EDWARDS ANGELL PALMER & DODGE LLP, P.O. BOX 55874, BOSTON, MA, 02205, US

(73) Assignee: Dryvit Systems, Inc., West Warwick, RI (US)

(21) Appl. No.: 12/077,545

(22) Filed: Mar. 20, 2008

Related U.S. Application Data
(60) Provisional application No. 60/919,282, filed on Mar. 21, 2007.

(51) Int. Cl. E04B 2/00; E04B 1/00; E04F 21/02; B05C 17/10

(52) U.S. Cl. 52/506.01; 52/741.4; 52/749.1; 15/235.6

(57) ABSTRACT

A drainage wall cladding system including a substrate backing assembly, an insulation layer, and elongated adhesive ribbons compressed between the substrate backing assembly and the insulation layer. Prior to compression, the ribbons have a base portion and a top portion formed on the base portion. After compression, the top portion is substantially compressed and the base portion is minimally compressed, wherein the adhesive ribbons are formed such that formation of cavities is minimized. Preferably, the base and top portions are trapezoidal in cross-sectional shape. A trowel or push box may be used to form the adhesive ribbons. An edge of such trowel and a blade of such push box define one or more notches to create ribbons with a trapezoidal base portion and a smaller trapezoidal top portion.

### CROSS-REFERENCE TO RELATED APPLICATION

This application claims priority to U.S. Provisional Patent Application No. 60/919,282, filed Mar. 21, 2007, which is incorporated herein by reference.

### BACKGROUND OF THE INVENTION

1. Field of the Invention

The subject disclosure relates to drainage wall cladding systems assembled with trapezoidal adhesive ribbons, and to trowels, push boxes and methods for forming improved adhesive ribbons used to cement the drainage wall cladding layers together.

2. Background of the Related Art

In building envelopes of any type, retained water in excess of a given material's tolerance, may lead to deterioration of the structure. As a result, care must be taken to prevent such water retention. Thus, building envelope constructions are designed and engineered to minimize water retention. Additionally, many building codes impose strict water retention standards to wall cladding systems.

One component of the building envelope may be the cladding system. An exemplary exterior insulation and finish system is shown in of U.S. patent application Ser. No. 11/166,563 filed on Jun. 24, 2005 (the '563 patent application), which is incorporated herein by reference. The '563 patent application shows an outer layer 32 of a building that is sealed by an adhesive layer 34. A trowel 100, seen in FIGS. 3, 5 and 6 of the '563 application, applies the adhesive layer 34. The trowel 100 has an edge 110 with spaced apart teeth 120. By floating and plowing the adhesive with the trowel 100, a first portion 38 of adhesive substantially covers the outer layer 32 and a second portion 40 of adhesive creates a series of adhesive ridges 60 on the first portion 38. An insulation board 44 is applied by hand pressure to create vertical channels 42 intermediate the ridges 60 for conducting fluid.

Despite the efficacy of the '563 patent application, the ridges 60 can undesirably deform under excessive compression of assembly. The deformation may be in the form of curling, folding and the like.

### SUMMARY OF THE DISCLOSURE

The subject technology forms ribbons that have stiff enough compressibility to prevent full contact between the adjacent layers of a cladding system while reducing surface area that can retain water.

The ribbons are also shaped, spaced and sized to promote proper adhesive contact area while being relatively easy to properly apply. The ribbons are shaped to provide some compressibility and a large adhesive contact area, while reducing the number of cavities or sidewalls that can retain water. The ribbons are also preferably sized and configured to properly set the gap between the substrate backing layer and insulation board.

In one embodiment, the subject technology is directed to a drainage wall cladding system including a substrate backing layer, an insulation board, and means for securing the insulation board to the substrate backing layer. The securing means provides: i) less surface area to reduce water retention; and ii) ample contact area to create proper adhesion between the substrate backing layer and the insulation board. The means for securing is a plurality of adhesive ribbons. The adhesive ribbons are elongated and may have a cross-sectional shape that is a trapezoidal base. The adhesive ribbons may also have a relatively smaller trapezoidal portion on top of the trapezoidal base. The ribbon preferably extends vertically from the top to the bottom of an insulation board when assembled. The ribbon is formed by a trowel, push-box and the like.

A preferred trowel for forming the adhesive ribbons includes a handle, a planar portion extending from the handle and an end attached to the planar portion. The end forms two apertures that define the cross-sectional shape or profile of the ribbons.

In a preferred method, the drainage wall cladding system is assembled by cementing an insulation board to a substrate. The method of cementing includes forming a plurality of adhesive ribbons on the insulation board, wherein each ribbon has a bottom and top surface with a sidewall extending between the bottom and top surface and applying the insulation board to the substrate such that the ribbons are partially compressed to attach the insulation board to the substrate and create drainage channels therebetween. During compression, if a portion of the top surface of the ribbon is folded or curled over to create a cavity, the sidewall provides material to substantially or completely fill the cavity.

In one aspect, the subject technology is directed to a drainage wall cladding system including a substrate backing assembly, an insulation layer, and elongated adhesive ribbons compressed between the substrate backing assembly and the insulation layer. Prior to compression, the ribbons have a base portion and a top portion formed on the base portion. After compression, the top portion is substantially compressed and the base portion is minimally compressed, wherein the adhesive ribbons are formed such that formation of cavities is minimized. Preferably, the base and top portions are trapezoidal in cross-sectional shape. The base portion may be sized and configured to set a gap between the substrate backing assembly and the insulation layer. The top portion may be smaller such as less than half a relative size of the base portion. Further, the cladding system may include a base layer of adhesive substantially covering one of the substrate backing assembly and the insulation layer in order to form a water barrier coating, wherein the base adhesive layer is integrally formed with the at least one adhesive ribbon by a trowel.

In another aspect, the subject technology is directed to a trowel for forming ribbons of adhesive on a board. The trowel has a substantially planar portion with an edge defining means for forming adhesive ribbons. A handle extends from the substantially planar portion.

Preferably, the means is a notch in a shape selected from the group consisting of: a trapezoid; a trapezoidal base portion and an arcuate top portion; an arcuate base portion and an arcuate top portion; an arcuate portion; a trapezoidal base portion with an off-center trapezoidal top portion; and a rectangular base portion with a rectangular top portion.

In another aspect, the subject technology is directed to a method for cementing an insulation board to a substrate assembly comprising the steps of: forming a plurality of adhesive ribbons on the insulation board, wherein each ribbon has a bottom surface and a top surface with sidewalls extending between the bottom surface and the top surface; and applying the insulation board to the substrate such that the ribbons are partially compressed to attach the insulation board to the substrate and create drainage channels therebetween, wherein during compression, if a portion of the top surface is folded or curled over to potentially create a cavity, the ribbon provides material to substantially fill the cavity. A trowel, push box or the like may be used to form the plurality of adhesive ribbons.

In still another aspect, the subject technology is a push box for applying adhesive ribbons to insulation layers including a platform adapted and configured to allow the insulation layers slide there across, a gusset plate assembly attached to the platform for guiding the insulation layers and a blade fixed to the gusset plate. The blade defines a plurality of notches so that adhesive applied to the insulation layers adjacent the blade passes through the plurality of notches to form the adhesive ribbons on the insulation layers, the adhesive ribbons having a substantially flat bottom surface, a substantially flat top surface and a substantially flat angled sidewall extending from the bottom surface to the top surface.

Preferably, a position of the blade can be adjusted to accommodate the insulation layers of a different thickness. The push box may also include a second blade for attaching to the gusset plate, the second blade for replacing the blade and defining a plurality of different notches.

It should be appreciated that the present invention can be implemented in numerous ways, including as a process, an apparatus, a system, a device, a method for applications now known and later developed. These and other features of the system disclosed herein will become more readily apparent from the following description and the drawings.

### BRIEF DESCRIPTION OF THE DRAWINGS

So that those having ordinary skill in the art to which the disclosed system appertains will more readily understand how to make and use the same, reference may be had to the drawings wherein:

FIG. 1 is a schematic representation in partial cross-sectional perspective of various layers forming a drainage type exterior insulation and finish system;

FIG. 1A is a horizontal cross-sectional view taken through the drainage type exterior insulation and finish system of FIG. 1;

FIG. 1B is a detailed view of a compressed adhesive ribbon in the area of circle 1B on FIG. 1A;

FIG. 2 is a schematic representation of the adhesive ribbons being applied to the insulation board in the drainage type exterior insulation and finish system of FIG. 1;

FIG. 3 is a perspective view of a hand tool used to form adhesive ribbons in accordance with the subject technology;

FIG. 3A is a top detailed view of a single notch in the hand tool in the area of circle 3A of FIG. 3.

FIG. 4 is various cross-sectional views of different notch profiles in accordance with the subject technology;

FIG. 5A is a top plan view of a push box for applying adhesive ribbons to an insulation layer in accordance with the subject technology;

FIG. 5B is a side view of the push box of FIG. 5A;

FIG. 5C is a cross-sectional view, taken along line C-C, of the push box of FIG. 5A; and

FIG. 5D is a detailed view of the blade in the push box of FIG. 5A.

### DETAILED DESCRIPTION OF PREFERRED EMBODIMENTS

The present invention improves upon the prior art for adhering drainage wall cladding systems and tools for making such systems. The advantages, and other features of the system disclosed herein, will become more readily apparent to those having ordinary skill in the art from the following detailed description of certain preferred embodiments taken in conjunction with the drawings which set forth some representative embodiments of the present invention. All relative descriptions herein such as left, right, up, down, horizontal and vertical are with reference to the Figures, and not meant in a limiting sense. Additionally, for clarity common items such as screws and nails have not been included in the Figures as would be appreciated by those of ordinary skill in the pertinent art.

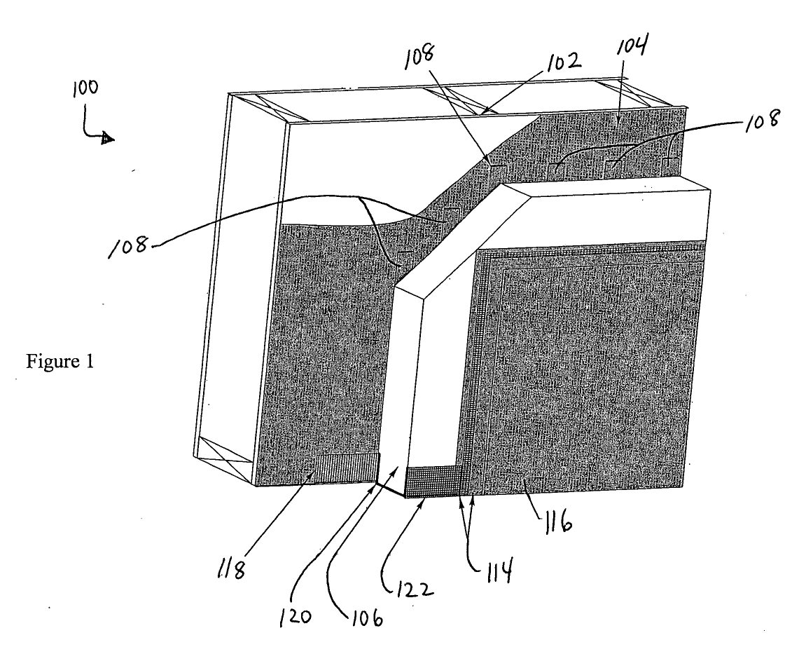

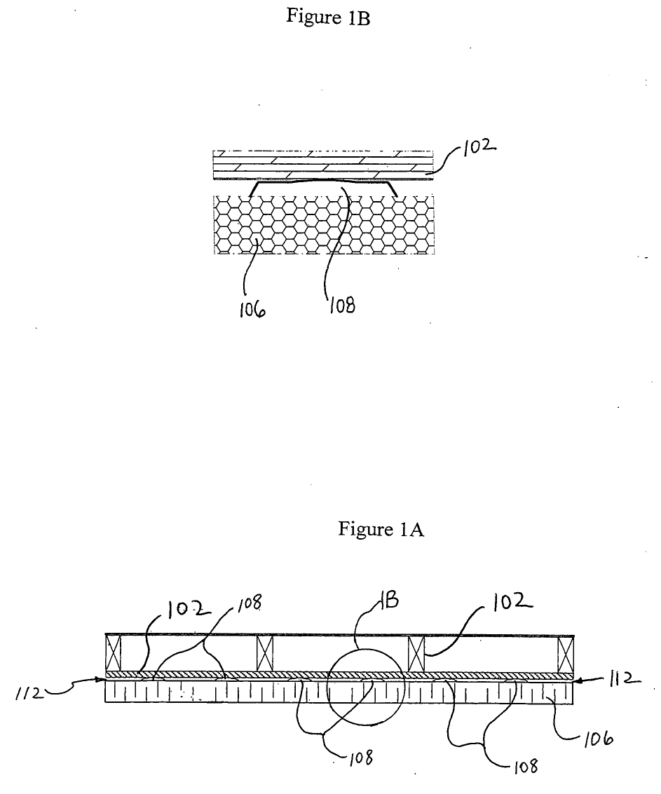

Referring to FIG. 1, a schematic representation in partial cross-sectional perspective of various layers forming a drainage type exterior insulation and finish system 100 is shown. Also referring to FIG. 1A, a horizontal cross-sectional view taken through the completed system 100 of FIG. 1 is shown. The system 100 provides components assembled to minimize water retention while being assembled efficiently and with a high degree of quality and consistent results.

The system 100 includes a sheathing and substrate assembly 102 covered with a water resistant membrane and air barrier 104. The substrate assembly 102 and barrier 104 provide a vertical base structure that is water resistant. A preferred barrier 104 is BACKSTOP® NT available from Drvit Systems, Inc. of West Warwick, R.I.

An outer insulation layer 106 is fixed in place with respect to the barrier 104 by a plurality of adhesive ribbons 108. The ribbons 108 act to set a gap 110 between the barrier 104 and insulation layer 106, wherein the gap 110 has vertical drainage channels 112 intermediate the ribbons 108. As described below in more detail, the ribbons 108 are shaped and spaced so that cavities are not significantly formed, if at all, during assembly of the system 100. In FIGS. 1, 1A and 1B, the ribbons 108 are shown after compression.

The system 100 also includes a base coat 114 and an outermost finish coat 116 applied to the insulation layer 106 in order to create the desired appearance and provide durability. A mesh fabric 122 is utilized to enhance the performance of the base coat 114 and finish coat 116. At ground level, the system 100 has a corrugated drainage strip 118 adhered to the barrier 104 and a protective wrapping 120 on the insulation layer 106.

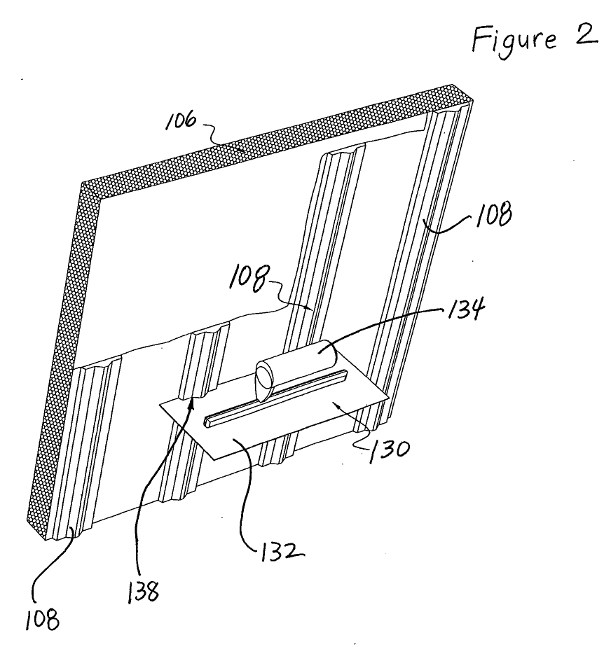

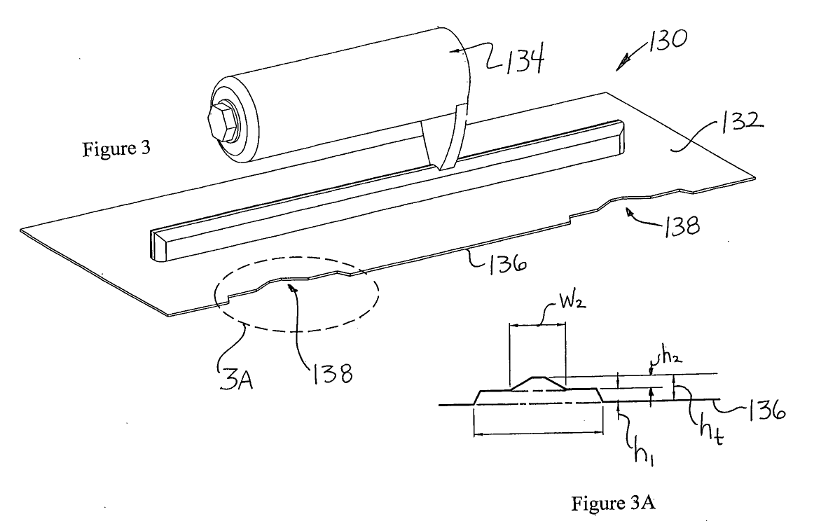

FIG. 1B is a detailed view of a compressed adhesive ribbon 108 in the area of circle 1B on FIG. 1A. Prior to assembly, the ribbon 108 had a base portion 140 and a top portion 142 (see FIG. 3A). The top portion 142 is substantially compressed or flattened during assembly of the system 100, whereas the base trapezoid 140 provides sufficient resistance to be minimally compressed, if at all. Thus, the drainage channels 112 are properly formed.

Referring now to FIG. 2, a schematic representation of the adhesive ribbons 108 being applied to the insulation board 106 in the system 100 is shown. A trowel 130 is applying the ribbons 108. The trowel 130 is designed to be easily used by a person to apply the ribbons 108 manually with the insulation board 106 held vertically, horizontally or otherwise as desired by the technician. Of course, the ribbons 108 may also be applied to the substrate assembly 102 where the adhesive material is designed for such function. The ribbons 108 are preferably PRIMUS® DM adhesive available from Drvit Systems, Inc. of West Warwick, R.I. At corners and edges, a simple flat ribbon (not shown) of adhesive may be used.

Referring now to FIG. 3, a perspective view of the trowel or hand tool 130 is shown. The trowel 130 is configured to efficiently and easily apply the adhesive ribbons 108 in the system 100. The trowel 130 has a substantially flat, rigid rectangular plate 132 with a handle 134 mounted thereon. One long edge 136 of the plate 132 defines two spaced notches 138. By drawing the trowel 130 over adhesive, the adhesive is scraped from the respective surface except in the area of the notches 138. Hence, ribbons 108 with the profile of the notches 138 are formed. In a preferred embodiment, the plate 132 is 12×5 inches and the notches 138 are spaced 7 inches apart. The spacing of the adhesive ribbons 108 allows for relatively fewer ribbons than as compared to the prior art. Fewer ribbons 108 mean fewer respective sidewalls are present in the resulting cladding system 100.

Referring now to FIG. 3A, a top detailed view of a single notch 138 in the trowel 130 is shown. Each notch 138 is roughly described as a base trapezoid 140, shown in dashed lines, with a smaller trapezoid 142 centrally located on top of the base trapezoid 140. In a preferred embodiment, the base trapezoid 140 tapers down from about 2.5 inches in width w₁, whereas the smaller trapezoid 142 tapers down from about 1.08 inches in width w₂. A respective height h₁, h₂ of each trapezoid 140, 142 is preferably about 0.25 inch, which would result in a total height hₜ of about 0.5 inch.

Adhesive ribbons 108 formed by the trowel 130 will have the shape of the notches 138. Without being limited to any particular theory, the smaller trapezoid 142 is largely compressed or flattened during assembly of the system 100, whereas the base trapezoid 140 provides sufficient resistance to be minimally compressed, if at all (see FIG. 1B). As a result, the extending sidewalls of the trapezoids 140, 142 provide material to prevent, mitigate and/or fill cavities that may result from curling effects. Also, the gap 112 is set between the substrate assembly 102 and insulation layer 106 to be approximately equal to the height h₁ of the base trapezoid 140.

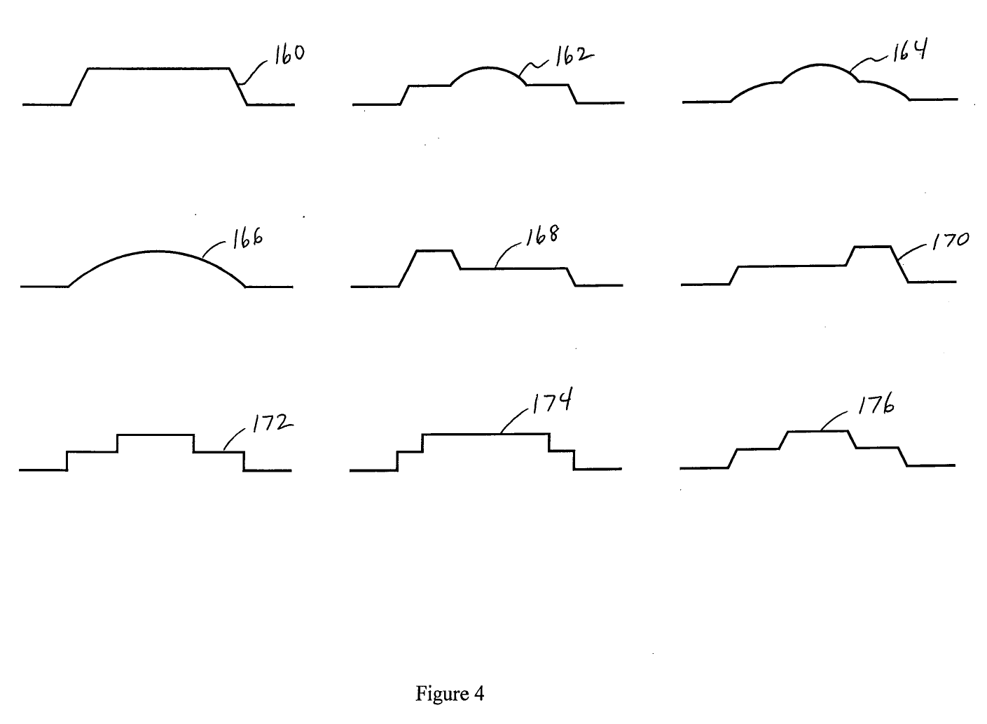

Referring to FIG. 4, various cross-sectional views of different notch profiles 160-176 in accordance with the subject technology are shown. In order to form various ribbons within the scope of the subject disclosure, the trowel 130 is modified to have corresponding notch profiles. Additionally, the configurations, such as the width or base-to-top width or height ratios may vary significantly. Preferably, each profile provides the benefits of material to fill in curling related cavities. Further, the ribbons also may provide an initial compressibility that increases after some compression of the top portion in order to facilitate the technician being able to easily and manually set the channel or gap 112.

Notch profile 160 is a simple trapezoid Notch profile 162 is a trapezoidal base portion with an arcuate top portion. Notch profile 164 is an arcuate base portion with an arcuate top portion. Notch profile 166 is an arcuate portion. Notch profiles 168, 170 are trapezoidal base portions with respective off-center trapezoidal top portions. Notch profiles 172, 174 are rectangular base portions with respective rectangular top portions. Notch profile 176 is a trapezoidal base portion with a trapezoidal top portion. It is envisioned that various base portions may be mixed and matched with one or more various top portions to form a great number of highly effective ribbon profiles, each with the scope of the subject disclosure.

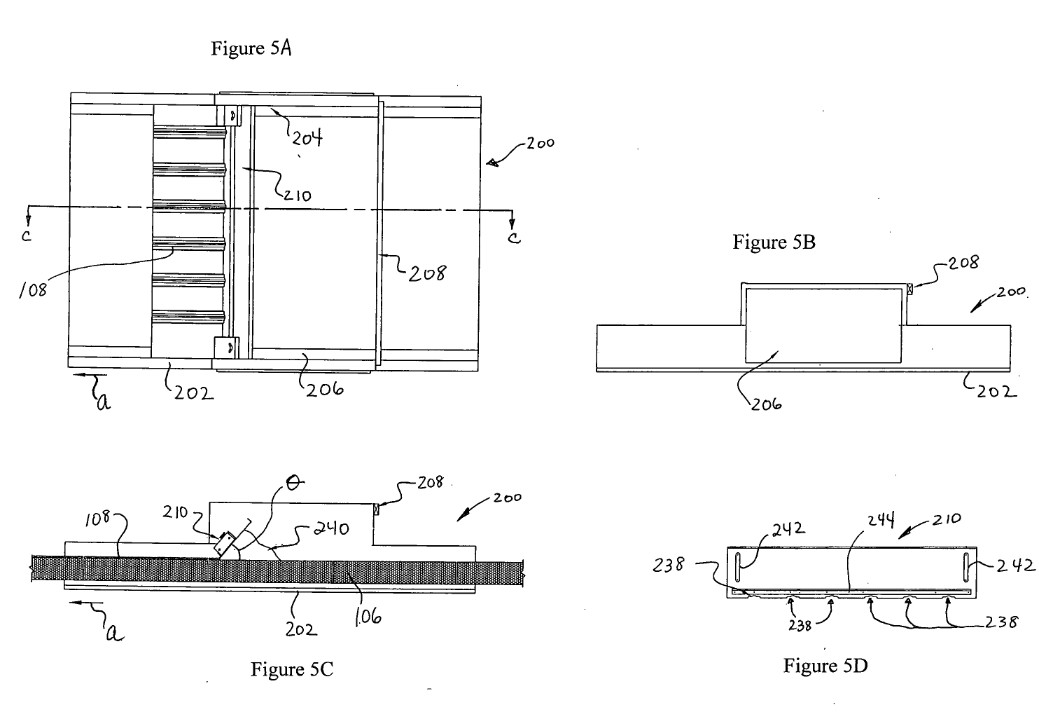

Referring now to FIGS. 5A-5C, various views of a push box 200 for applying adhesive ribbons 108 to an insulation layer 106 are shown. The push box 200 allows a technician to more repeatably and quickly apply adhesive ribbons 108 to the desired area on the insulation layer 106. The push box 200 includes a platform 202 that may be supported by a table (not shown) or the like. The platform 202 has runners 204 that are sized and shaped so that insulation layers 106 may slide across the platform 202 along as shown by arrows “a”. A gusset plate 206 and brace 208 act as a guide for the insulation layers 106 and retain a blade 210 in a fixed position with respect to the insulation layers 106.

The blade 210 is fixed at an angle “Θ” so that the notches 238 are adjacent the insulation layer 106. The insulation layer 106 can pass along arrows “a”, but by depositing adhesive 240 on the insulation layer 106, the adhesive 240 passes through the notches 238 to form the desired adhesive ribbons 108 on the insulation layer 106.

Referring to FIG. 5D, a detailed view of the blade 238 in the push box 200 is shown. The blade 210 defines six notches 238. Because of the arrangement of the push box 200, the blade 210 can be configured to have a large number of notches or just a few. As shown, the push box 200 creates six adhesive ribbons 108 in a single pass. The repeatability of the resulting ribbons 108 is more consistent because the gap is mechanically set. In one embodiment, the blade 210 is 10×4 inches with a spacing between each notch of five inches.

The blade 210 also includes slotted mounting holes 242 so that various thickness insulation layers 106 may be used and various thickness adhesive base coats may be applied as desired. Additionally, the gusset plate 206 may have slotted holes (not shown) to allow reconfiguration and, in turn, a different placement of the blade 210. Alternatively, the notches 238 of the blade 210 may be any configuration of the subject technology or other similar configurations. The blade 210 may include a stiffening ridge 244 located behind the notches 238.

Unless otherwise specified, the illustrated embodiments can be understood as providing exemplary features of varying detail of certain embodiments, and therefore, unless otherwise specified, features, components, modules, elements, and/or aspects of the illustrations can be otherwise combined, interconnected, sequenced, separated, interchanged, positioned, sized, and/or rearranged without materially departing from the disclosed systems or methods. Additionally, the shapes and sizes of components are also exemplary and can be altered without materially affecting or limiting the disclosed technology. While the invention has been described with respect to preferred embodiments, those skilled in the art will readily appreciate that various changes and/or modifications can be made to the invention without departing from the spirit or scope of the invention as defined by the claims.

1. A drainage wall cladding system comprising:
a substrate backing assembly;
an insulation layer; and
at least one elongated adhesive ribbon compressed between the substrate backing assembly and the insulation layer, wherein, prior to compression, the at least one adhesive ribbon had a base portion and a top portion formed on the base portion and, after compression, the top portion is substantially compressed and the base portion is minimally compressed, wherein the at least one adhesive ribbon is formed such that formation of cavities is minimized.

2. A drainage wall cladding system as recited in claim 1, wherein the base and top portions are trapezoidal in cross-sectional shape.

3. A drainage wall cladding system as recited in claim 1, wherein the base portion is sized and configured to set a gap between the substrate backing assembly and the insulation layer.

4. A drainage wall cladding system as recited in claim 3, wherein the gap is substantially equal to a height of the base level.

5. A drainage wall cladding system as recited in claim 1, wherein the top portion is less than half a relative size of the base portion.

6. A drainage wall cladding system as recited in claim 1, wherein the top level is integrally formed with the base level.

7. A drainage wall cladding system as recited in claim 1, further comprising a base layer of adhesive substantially covering one of the substrate backing assembly and the insulation layer in order to form a water barrier coating, wherein the base adhesive layer is integrally formed with the at least one adhesive ribbon by a trowel.

8. A trowel for forming ribbons of adhesive on a board comprising:
a substantially planar portion, wherein the substantially planar portion has an edge defining means for forming adhesive ribbons that minimize cavity formation due to curling during compression; and
a handle extending from the substantially planar portion.

9. A trowel as recited in claim 8, wherein the means is a notch in a shape selected from the group consisting of: a trapezoid; a trapezoidal base portion and an arcuate top portion; an arcuate base portion and an arcuate top portion; an arcuate portion; a trapezoidal base portion with an off-center trapezoidal top portion; and a rectangular base portion with a rectangular top portion.

10. A trowel as recited in claim 8, wherein the means is a notch having a base portion and a top portion, the top portion being a trapezoidal shape.

11. A trowel as recited in claim 10, wherein the base portion is a trapezoidal shape.

12. A trowel as recited in claim 8, wherein the edge defines two notches as the means.

13. A method for cementing an insulation board to a substrate assembly comprising the steps of:
forming a plurality of adhesive ribbons on the insulation board, wherein each ribbon has a bottom surface and a top surface with sidewalls extending between the bottom surface and the top surface; and
applying the insulation board to the substrate such that the ribbons are partially compressed to attach the insulation board to the substrate and create drainage channels therebetween, wherein during compression, if a portion of the top surface is folded or curled over to potentially create a cavity, the ribbon provides material to substantially fill the cavity.

14. The method according to claim 13, further comprising the step of using a trowel to form the plurality of adhesive ribbons, the trowel having two notches in order to form two ribbons simultaneously.

15. The method according to claim 13, wherein the top surface, the bottom surface and the sidewalls form a base portion that is trapezoidal or rectangular in shape and a top portion that is a shape selected from the group consisting of square, trapezoidal, arcuate and combinations thereof.

16. The method according to claim 13, further comprising the step of using a push box to form the plurality of adhesive ribbons, the push box having at least two notches formed in a blade in order to form at least two ribbons simultaneously.

17. A push box for applying adhesive ribbons to insulation layers comprising:
a platform adapted and configured to allow the insulation layers slide there across;
a gusset plate assembly attached to the platform for guiding the insulation layers; and
a blade fixed to the gusset plate, the blade defining a plurality of notches so that adhesive applied to the insulation layers adjacent the blade passes through the plurality of notches to form the adhesive ribbons on the insulation layers, the adhesive ribbons having a substantially flat bottom surface, a substantially flat top surface and a substantially flat angled sidewall extending from the bottom surface to the top surface.

18. A push box as recited in claim 17, wherein a position of the blade can be adjusted to accommodate the insulation layers of a different thickness.

19. A push box as recited in claim 17, further comprising a second blade for attaching to the gusset plate, the second blade for replacing the blade and defining a plurality of different notches.
